(19) United States
(12) Patent Application Publication
(10) Pub. No.: US 2021/0044559 A1
(43) Pub. Date: Feb. 11, 2021

(54) CHAT GROUP RECOMMENDATIONS FOR CHAT APPLICATIONS

(71) Applicant: MICROSOFT TECHNOLOGY LICENSING, LLC, Redmond, WA (US)

(72) Inventors: Atishay JAIN, Meerut (IN); Pratik Kumar JAWANPURIA, Hyderabad (IN); Purushottam Madhukar KULKARNI, Hyderabad (IN)

(73) Assignee: MICROSOFT TECHNOLOGY LICENSING, LLC, Redmond, WA (US)

(21) Appl. No.: 16/537,457

(22) Filed: Aug. 9, 2019

(51) Int. Cl. H04L 12/58; G06F 11/34

(52) U.S. Cl. CPC H04L 51/32; G06F 11/3438; H04L 51/16

(57) ABSTRACT

A system includes a compiler that monitors activity of a user in a chat application, the chat application including an electronic platform for one or more individuals to communicate in a group in real-time over a computer network. A processor is connected to the compiler and generates a ranked list of groups in the chat application based on the activity of the user. A display is connected to the processor and displays the groups on an interface of the user based on the ranked list where higher ranked groups are displayed above lower ranked groups in the interface of the user.

### BACKGROUND

Communication by instant messaging has become commonplace both professionally and socially because of the near-ubiquitous use of communication devices and the availability of mobile chat applications. Chat applications typically cluster messages into groups, where a message from one group member is sent to each member in the group. Groups can be formed with members having common characteristics or interests, such as, for example, family, work, friends, cooking, travel, sports, art, etc. Chat applications display groups on the user interface, where groups are displayed from top to bottom in reverse chronological order, where the groups having the most recent activity (e.g., messages sent or received) are displayed towards the top of the user interface.

A user can have a lot of active group conversations. For a small mobile screen, it can become difficult for the user to prioritize group conversations that he or she would like to focus on once there are a large number of (e.g., 50) active group conversations. When a user is using chat-based communication for work, then this problem becomes bigger because the user can have multiple groups for multiple areas of work or stakeholders. Thus, there remain significant areas for new and improved methods for recommending groups to a user that enable the user to prioritize groups in a chat application.

### SUMMARY

A system, in accordance with a first aspect of this disclosure, includes a compiler that monitors activity of a user in a chat application, the chat application including an electronic platform for one or more individuals to communicate in a group in real-time over a computer network. A processor is connected to the compiler and generates a ranked list of groups in the chat application based on the activity of the user. A display is connected to the processor and displays the groups on an interface of the user based on the ranked list where higher ranked groups are displayed above lower ranked groups in the interface of the user.

A method, in accordance with a second aspect of this disclosure, includes monitoring activity of a user in a chat application, the chat application including an electronic platform for one or more individuals to communicate in a group in real-time over a computer network. A ranked list of groups is generated in the chat application based on the activity of the user. The groups are displayed on an interface of the user based on the ranked list where higher ranked groups are displayed above lower ranked groups in the interface of the user.

A computer readable medium, in accord with a third aspect of this disclosure, includes a computer readable storage medium having encoded thereon: first program instructions executable by a device to cause the device to monitor activity of a user in a chat application, the chat application including an electronic platform for one or more individuals to communicate in a group in real-time over a computer network. Second program instructions are executable by the device to cause the device to generate a ranked list of groups in the chat application based on the activity of the user. Third program instructions are executable by the device to cause the device to display the groups on an interface of the user based on the ranked list where higher ranked groups are displayed above lower ranked groups in the interface of the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram illustrating a system for recommending chat groups in a chat application;

FIG. 2 is a diagram illustrating a recommendation pipeline;

FIG. 3 is a table illustrating datapoint aggregation;

FIG. 4 is a sequence flow diagram illustrating a system and method for generating chat group recommendations;

FIG. 5 illustrates a user interface of a chat application;

FIG. 6 is a table illustrating features used by the machine learning (ML) based model;

FIG. 7 is a flow diagram illustrating a recommendations data flow;

FIG. 8 is a flow diagram illustrating a method for recommending chat groups in a chat application; and

FIG. 9 is a diagram illustrating a computer program product for recommending chat groups in a chat application.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following implementations introduce a system and method for recommending chat groups to a user in a chat application. The chat groups can be recommended based on the chat groups' relevance to the user. The system can include a data point collection unit that records user activity, aggregates the user activity, and stores the user activity in a database. Data can be loaded from the database into a recommendation engine, where the data can be ran on the recommendation engine periodically.

In at least one implementation, the system includes a light weight client-side ML model to recommend focus groups without any server interaction. The system can include a compiler, a processor and a display. The compiler may be configured to monitor activity of a user in a chat application. The chat application may include an electronic platform for one or more individuals to communicate in a group in real-time over a computer network. In one specific example, the term “group” includes an electronic conversation between two or more users in a chat application. The term “group” can also include a conversation with just one user, where the user is the sender and recipient of message(s). The processor is connected to the compiler and may be configured to generate a ranked list of groups in the chat application based on the activity of the user. The display is connected to the processor and may be configured to display the groups on an interface of the user based on the ranked list where higher ranked groups are displayed above lower ranked groups in the interface of the user.

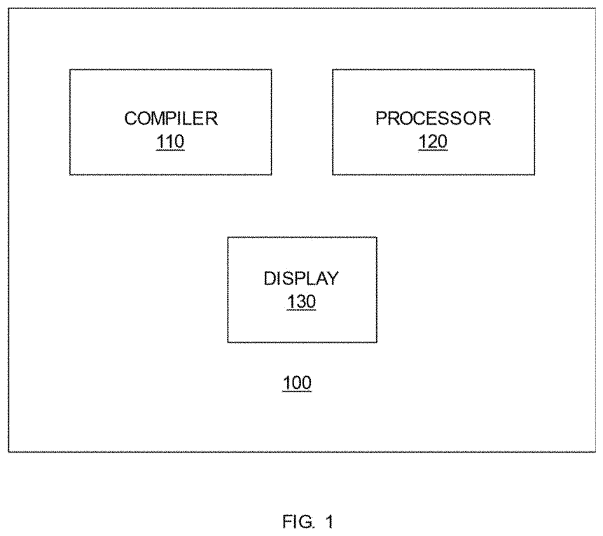

FIG. 1 is a diagram illustrating a system 100 for recommending chat groups in a chat application. The system includes a compiler 110, a processor 120, and a display 130. Although FIG. 1 illustrates the system components as being separate and distinct devices, the compiler 110, the processor 120, and the display 130 can be on a single device (e.g., a mobile phone). The compiler 110 (also referred to herein as a “listener”) monitors activity of a user in a chat application. As used herein, the term “compiler” may include a computer hardware component (e.g., a processor). The term “chat application” may include an electronic platform for one or more individuals to communicate in a group in real-time over a computer network, where messages are displayed on the user interface of the recipients (if the chat application is open) as soon as the messages are sent from the sender. Therefore, unlike traditional email applications, there is no need to refresh the inbox. Furthermore, the sender of a traditional email message is required to explicitly specify all of the recipients, whereas a chat application may not require the sender of a chat message to explicitly identify and specify each and every recipient of every chat message.

The activity of the user can include accessing a group in the chat application (e.g., opening or viewing a message in the group) and the number of times each group in the chat application is opened by the user. The activity of the user can also include the time spent by the user in each group and the number of messages sent by the user in each group, where messages include text messages, enhanced text messages like surveys, announcements, meeting invites and graphical messages, such as emojis, tiffs, likes, dislikes. In addition, the activity of the user can include the number of times that the user recommended the group or invited an individual to join the group.

The user activity described above can be used to identify groups that should be prioritized for the user. Conversely, the following user activity can be used to identify groups that should be de-prioritized for the user: the number of unread messages in each group and the number of times the user opened a message in each group for the sole purpose of marking the message as read.

The processor 120 is connected to the compiler 110 and may be configured to generate, without any server call, a ranked list of groups in the chat application based on the activity of the user. As used herein, the term “connected” can include operationally connected, logically connected, in communication with, physically or wirelessly connected, engaged, coupled, contacts, linked, affixed, and attached. In at least one implementation, the processor 120 is located on the device of the user.

The display 130 is connected to the processor 120. The display 130 may be configured to display the groups on an interface of the user based on the ranked list generated by the processor 120. In the ranked list, the higher ranked groups may be displayed above lower ranked groups in the interface of the user. In at least one implementation, the display 130 displays the groups on the interface in a non-chronological order.

The processor 120 can generate a first ranked list of groups for a first time period (e.g., 8:00 AM-5:00 PM, Monday-Friday), where the first ranked list of groups is based on the activity of the user during the first time period. The processor 120 can generate a second ranked list of groups for a second time period different from the first time period (e.g., Saturday and Sunday), where the second ranked list of groups is based on the activity of the user during the second time period. The display 130 can display the first ranked list of groups to the user during the first time period and display the second ranked list of groups to the user during the second time period.

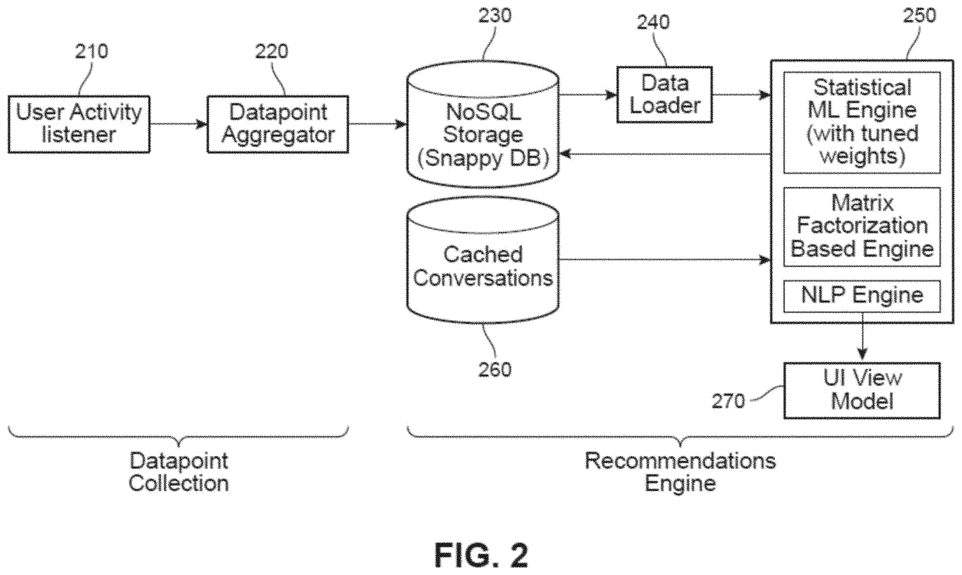

FIG. 2 is a diagram illustrating a recommendation pipeline. The recommendation pipeline can be divided into two components: datapoint collection and a recommendation engine. Datapoint collection can be used to record user activity (e.g., via a user activity listener 210) and aggregate the user activity (e.g., via a data point aggregator 220).

Telemetry datapoints indicate the activity of a user. For example, telemetry datapoints can indicate the number of times that a user accessed a chat group, the number of messages sent by the user to a specific chat group, and the number of times the user invited an individual to join a specific chat group. The user activity listener 210 (also referred to herein as a “compiler”) can add a listener to existing telemetry datapoints to monitor the activity of a user. This can utilize already existing datapoints where the ownership of the datapoints is already defined. In at least one implementation, the user activity listener 210 modifies existing listeners with minimal code change, where telemetry data points are captured for the system's use.

The datapoint aggregator 220 can perform a datapoint specific payload aggregation, including specific actions such as summing the datapoints, averaging the datapoints, calculating percentiles, etc. Telemetry datapoint aggregators may be designed as a monolithic pipeline. In other words, aggregators do not conventionally permit the addition of new aggregator. Thus, a telemetry datapoint aggregator may need to be refactored so that the system can add new aggregators. In one implementation, telemetry datapoints may be uploaded to a remote server via an external channel. However, a different channel can be adopted to upload the telemetry datapoints to storage on the user's device if the system is only interested in processing activities locally. Some datapoints may not be currently available in telemetry. The system can add a new user activity listener on the user actions that the system is interested in (e.g., the number of messages sent by the user to Group X).

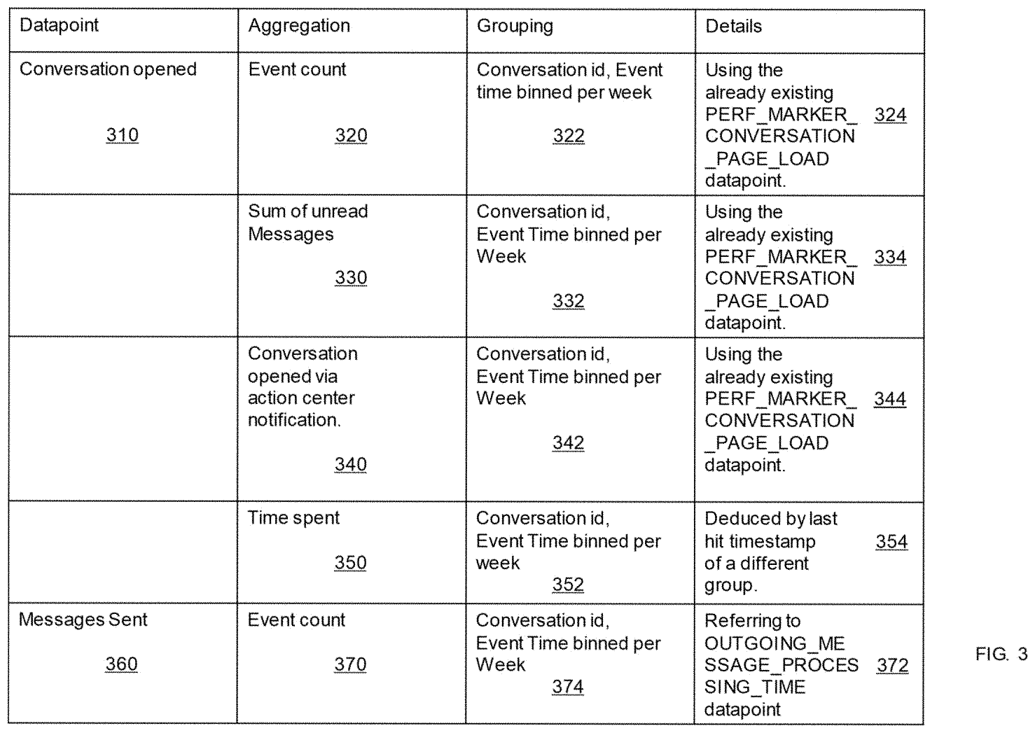

FIG. 3 is a table illustrating datapoint aggregation. When a group conversation is opened in the chat application 310, data can be aggregated as an event count (e.g., how many times did the user open the Chat Group A or a message in Chat Group A) 320. This activity can be grouped using Conversation id (e.g., Chat Group A) and event time binned per week 322 using the already existing PERF_MARKER_CONVERSATION_PAGE_LOAD datapoint 324. The sum of unread messages (e.g., in Chat Group B) can also be aggregated 330. This activity can be grouped using Conversation id (e.g., Chat Group B) and event time binned per week 332 using the already existing PERF_MARKER_CONVERSATION_PAGE_LOAD datapoint 334. An action center notification can be a notification displayed at the top of the home screen of a smartphone. Data can be aggregated related to a conversation opened via an action center notification (e.g., how many times did the user open a message in Chat Group C via an action center notification) 340. This datapoint can be grouped using Conversation id (e.g., Chat Group C) and Event Time binned per week (e.g., how much time did the user spend in Chat Group C) 342 using the already existing PERF_MARKER_CONVERSATION_PAGE_LOAD datapoint 344.

In addition, the amount of time spent (e.g., in Chat Group D) can aggregated 350 by grouping the conversation id (e.g., Chat Group D) and Event Time binned per week (e.g., how much time did the user spend in Chat Group D per week) 352. The amount of time spent can be deduced using the last hit timestamp of a different group 354. When messages are sent 360, data can be aggregated related to an event count (e.g., how many times did the user send a message in Chat Group E) 370 by referring to the OUTGOING_MESSAGE_PROCESSING_TIME datapoint 372. This activity can be grouped using Conversation id (e.g., Chat Group E) and Event Time binned per week (e.g., how much time did the user spend in Chat Group E) 374.

The user activity can be stored in a database 230 (e.g., a NoSQL Storage) instantly or at predetermined intervals (e.g., hourly, daily, weekly). In at least one implementation, the system includes a no SQL level database as used by telemetry aggregators, which may only store aggregated data per datapoint. In one specific example, for 50 chat groups with one month of data, disk usage may be 50 KB at max in at least one implementation.

Since write operations may occur more frequently than read operations, values can be stored per group, which can result in updating only the delta change in storage. This also minimizes any error in data aggregation. For example, at 12:00 PM, the database 230 provides that message X as the most recent message sent from the user. At 5:00 PM, the database 230 still provides that message X as the most recent message sent from the user message X even though message Y was sent from the user at 4:40 PM. This erroneous data may only occur in data that has changed between 12:00 PM and 5:00 PM. This error may be limited to the specific time duration for a particular group for a specific datapoint.

The no SQL database can store data in a key-value pair. A prefix key can be constructed by prefixing the key with some strings such as FocusGroup—Datapoint name etc. The database 230 can have the prefix key: Recommendation/FocusGroup/<DataPoint>/<Date Bucket>/<Conversation Id>. This can be the schema of the whole key. The key can be constructed by prefixing Recommendation,FocusGroup,<DataPoint>,<Date Bucket>,<Conversation Id>. The system can treat storage of group conversations differently. Group conversations that are not deleted can be treated in one way and stored in a certain way and group conversations that are deleted can be treated another way. Specifically, messages in a group stored in the database that are not accessed after a predetermined period (e.g., 2 months) can be deleted from the database. Conversely, if a group conversation is deleted at the user device, the group conversation can be saved in a remote database for a longer period (e.g., 1 month) in the event the user decides to rejoin the group at a later time.

The data can be retrieved from the database 230 via the data loader 240 and input into the recommendation engine 250, which can process the data periodically. Data from a conversations cache 260 can also be input into the recommendation engine 250. The recommendation engine 250 can include a statistical ML engine with tuned weights, a matrix factorization engine, and a natural language processing (NPL) engine. All of the processing can be done on a low priority background thread. More specifically, recommendation processing can occur during chat application idle time on a background thread periodically (e.g., once per day). The results can be computed and cached in the database 230 for a predetermined period (e.g., 2 day). The storage usage for the computed recommendations can be less than 50 Kb, in one specific example. The recommendations can be displayed to the user via a user interface view model 270. The system can utilize a linear model by categorizing user activity on a weekly and monthly time range. In addition, a ML model can be used where recommendations are generated based on few well-known Matrix Factorizing techniques. An NLP Engine can also be used where user content is read using a natural language processing-based model. This can help in understanding the interests of the user. To reduce the computational overhead, recommendations may be computed once per day and the results can be stored in the user database. These precomputed cached results can be used as the recommendations for the rest of the day.

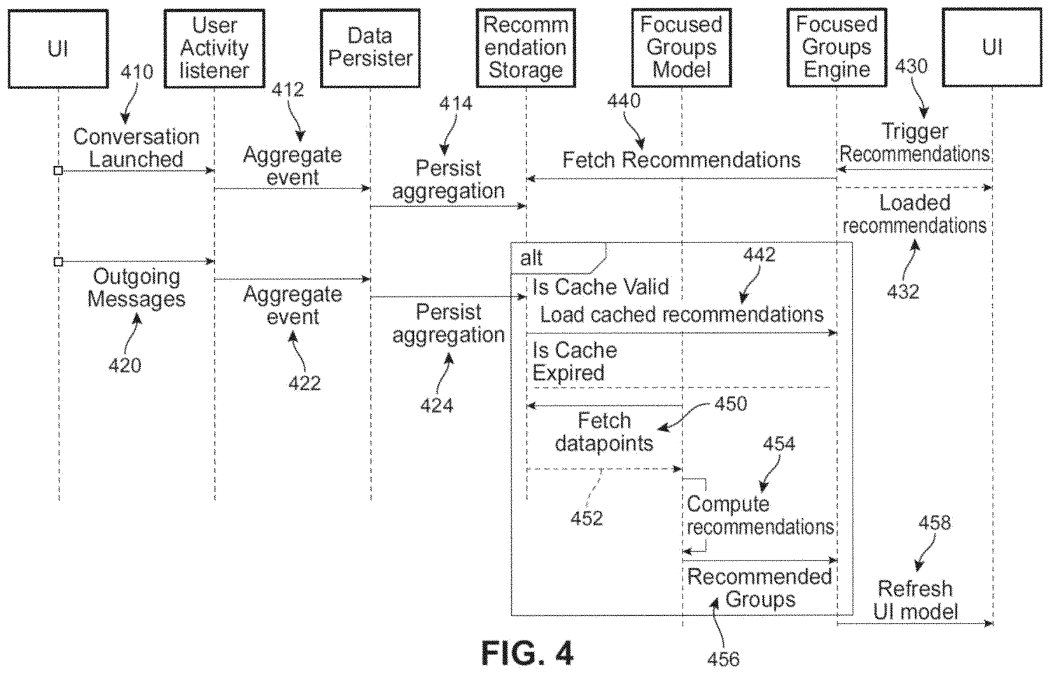

FIG. 4 is a flow diagram illustrating a process for generating chat group recommendations. A user activity listener can monitor/receive a conversation launched from a user interface (Step 410). A user activity listener can also monitor/receive outgoing messages from the user interface (Step 420). The user activity listener may then send the monitored/received aggregated data to the data persister (Steps 412, 422). The data persistor may persist the data and send the data to storage (Steps 414, 424). In one implementation, when data is persisted, it is denoted as data that is infrequently accessed and not likely to be modified. In at least one implementation, all of the data for this scope is infrequently accessed (read) and frequently updated in parts but not as a whole. Data that is frequently used can be sent to the data persister where it is persisted and sent to storage.

The generation of recommendations can be triggered at a user interface and communicated to focused groups engine (Step 430). This can occur, for example, when a threshold amount of user activity data has been collected by the user activity listener and the user opens the chat application. As described above, the focused group engine can send cached recommendations to the user interface (Step 432).

A request to fetch recommendations can be sent to storage by the focused group engine (Step 440). If the cache is valid (i.e., there are valid recommendations in storage), then recommendations can be loaded from storage to the focused groups engine (Step 442). If the cache is expired, then a request to fetch datapoints can be sent from a focused group model to the storage (Step 450); and, the storage can send datapoints to the focused group model (Step 452). As described below, recommendations can be computed at the focused group model, where aggregated user activity data is input into the focused group model and recommended groups is output from the focused group model (Step 454). Recommended groups can be sent from the focused group model to the focused group engine (Step 456); and, the focused group engine can refresh the user interface with the recommended groups (Step 458). Steps 440-458 can be performed after Step 432 in the background or Steps 440-458 can be performed in the background.

The chat group reordering can occur on a user interface view model where conventional ordering occurs. For example, there can be an isRecommended field in the IConversation object. The isRecommended field can control whether a group has been recommended or not. “Yes” may mean that the group has been recommended to the user; “No” means otherwise.

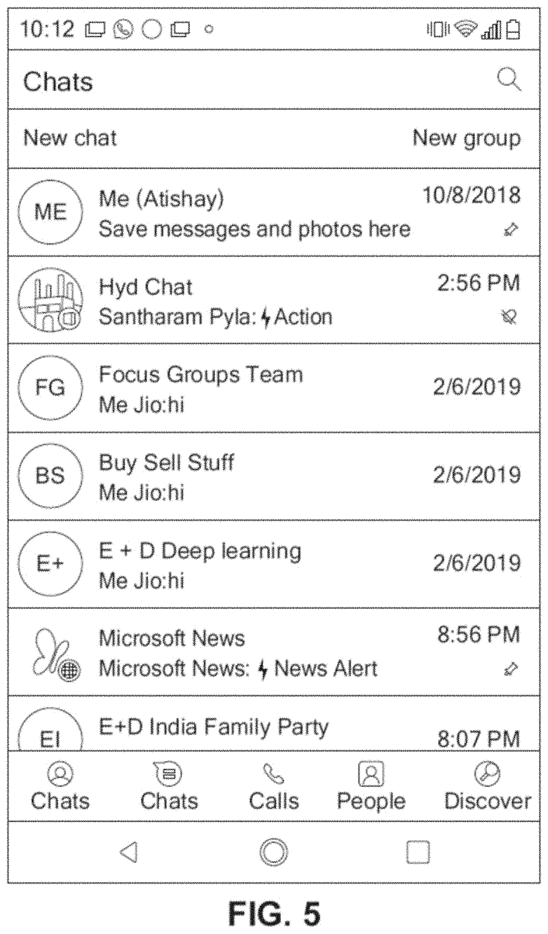

FIG. 5 illustrates an exemplary user interface of a chat application where seven groups are shown. The first group Me (Atishay) is pinned to the top of the user interface and includes all of the messages that the user has sent to himself. Although the exemplary interface shows one pinned group at the top of the groups list, it is recognized that the interface can display more or less pinned groups at the top of the groups list. Pinned groups can include groups that a user has explicitly marked to be always shown at the top of the group list. The next four groups from the top of the user interface are groups recommended to the user by the system. These includes Hyd Chat, Focus Groups Team, Buy Sell Stuff, and E+D Deep learning groups. Although the exemplary interface shows four recommended groups, it is recognized that the system can display more or less recommended groups towards the top of the chat listing.

The remaining groups (i.e., the groups that are not recommended by the system) can be displayed below the recommended groups. The remaining groups can be listed in chronological order. For instance, in this example, the Microsoft News group (last message received at 8:56 PM) is listed above the E+D India Family Party group (last message received at 8:07 PM).

In one implementation, each datapoint collection can take less than 1 millisecond to complete on a background thread. Database caching and flushing can be taken care by a snappy database (available from Google LLC, Menlo Park, Calif., USA). Recommendation computation can take 30-40 milliseconds. The in memory group conversation list can be reordered once when the user interface is loaded. Subsequent changes can be incremental and only affect the group conversation reporting activity. The system can run the recommendation engine to reorder the conversation list only once when the user launches the app. After that, user activity can be monitored in the background without performing any action on the user interface until the user closes the chat application.

In subsequent uses of the chat application, if the system needs to update the order of the groups based on recommendations, this can be done by replacing the group(s) whose order has changed.

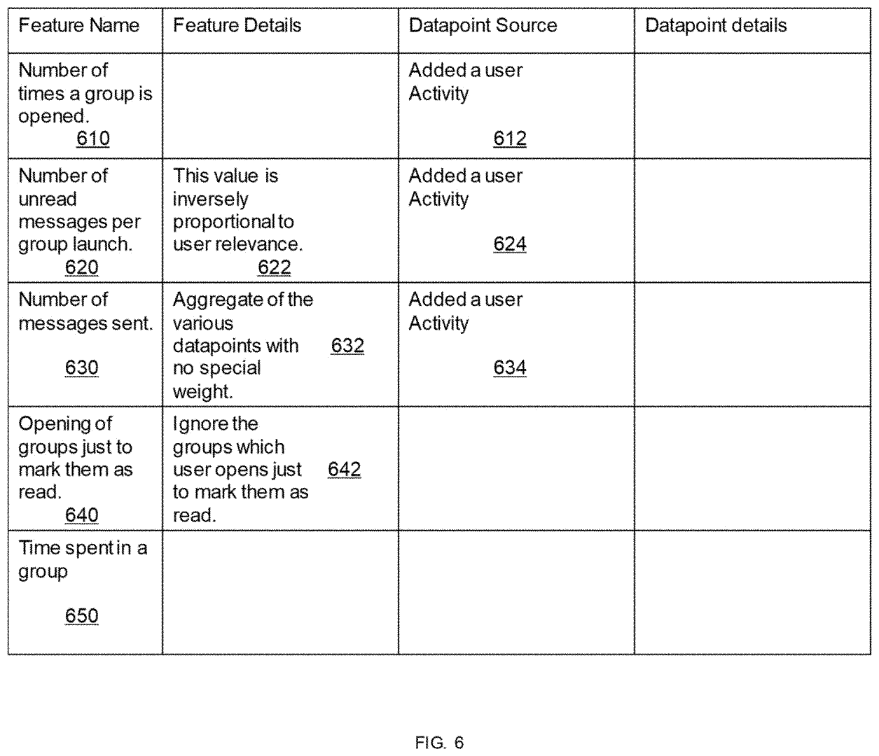

FIG. 6 is a table illustrating features used by the ML based model to make a recommendation. The features may include the number of times a group is opened 610, the number of unread messages per group launch 620, the number of messages sent 630, opening of groups just to mark them as read 640, and time spent in a group 650. The user activity 612 can be the datapoint source for the number of times a group is opened feature 610.

The value of the number of unread messages per group launch feature 620 can be inversely proportional to user relevance 622. The user activity 624 can be the datapoint source for the number of unread messages per group launch feature 620. The number of messages sent feature 630 can be an aggregate of the various datapoints with some specific weights 632. The user activity 634 can be the datapoint source for the number of messages sent feature 630. The opening of groups just to mark them as read feature 640 can be used where the user opens group(s) just to mark them as read and the opened group(s) are ignored by the user 642.

The features can be combined on multiple time bins, such as, for example, “last month” and “last week.” The features can be combined using trained weights that can be fine-tuned. The final rankings can be generated in order of number of times the groups are opened. One-on-one group chats can be given top priority if there is unread communication. Their order can be purely a user interface treatment with no corresponding ML feature.

When a new user starts using the chat application, there may be no recommendations generated if there is no user data. The system can use two thresholds to initiate the generation of group recommendations. First, recommendations can be generated when there is a threshold amount of activity in a particular group or a set of groups that is clearly distinguishable from other groups. For example, the first threshold is triggered when a group is 2 times more active than other groups. The second threshold is a time bound usage. Regardless of significant group usage, the ML based model can start generating recommendations after a threshold amount of time (e.g., 1 week) of user activity.

The system can add telemetry datapoints to capture the order in which the user opens groups on the user interface. These datapoints can be used to prioritize the groups in the ranked list. Additional telemetry data points can include groups that were recommended to other individuals and the number of groups recommended to the user. Group recommendations to a first user may be given higher priority than group recommendations to a second user if the first user has been given 7 total group recommendations and the second user has been given over 100 group recommendations.

The system can attempt to reconstruct the original group order based on message received telemetry indicating the chronological order in which the messages were received in the chat application. Groups can be divided into 4 categories: pinned, recommended, non-recommended visible in first display screen (approximate), and not on the first display screen. As illustrated in FIG. 5, a group can be pinned to the user interface by the user. The recommended groups can be displayed under any pinned groups. Non-recommended groups visible in the first display screen can be displayed under the recommended groups. Groups not on the first display screen can be viewed by scrolling down on the user interface.

The group conversation list user interface can be divided into following at least 3 categories: primary attention section, secondary attention section, and non-attention section. The primary attention section can include the top portion of the user's screen (e.g., the top half), which may grab the most attention. The secondary attention section can include a bottom portion of the user's screen (e.g., the bottom half), which may get less attention than the primary section. The non-attention section can include the second screen of the listing of groups and any subsequent screens. The system can compare each group conversation in this category from original order and new order.

Based on this data, the system can deduce the user effort required to locate a group conversation. Each group conversation category can have a negative weight that increases with the ordering of the group conversation. In other words, the longer a group goes without user activity, the further the group is de-prioritized by the system. The system can also deduce group conversations missing the user's attention based on a comparison of the original versus the new list order. Moreover, the system can deduce the usage distribution by group conversation based on the user activity data. For example, the system can deduce that the user spends 17% of his time in Group A, 10% of the user's sent messages are to Group B, and 22% of the user's read messages are from Group C. The usage distribution information can help the system answer questions such as whether an artificial focus boundary can be drawn for the user, such as a box enclosing recommended groups, a line separating recommended from non-recommended groups, or a color scheme to highlight recommended groups. The usage distribution information can also be used to determine whether premium visible space is being wasted in the original user interface by displaying non-recommended groups towards the top of the screen. In a scenario where a user opens a 6th or 7th ordered group with a similar affinity as the top 5 groups, the system can identify the 6th or 7th ordered group as deserving a high ranking.

In at least one implementation, all of the datapoints are processed and aggregated on the client side and not on a remote device. Thus, the ML features can be computed on the client side and the recommendations generated based on a light weight client-side model. This can remove server overhead and allow datapoints to be added faster. Thus, the ML features can perform even when the user is not online. The client side only design can also be fully compliant where the user is in control of his or her data. Specifically, only the user may know what the recommendations are, thereby avoiding privacy issues.

The system can utilize telemetry listeners. A listener can be used in client aggregation for metrics and events. Frequent events and metrics can be aggregated in the chat application and uploaded to storage in a bucketized fashion at a predetermined interval (e.g., every 24 hours). The datapoints can be aggregated using this mechanism and processed according to the system's schedule. Each aggregation may involve a no SQL database write, which is potential overhead. In addition, the chat application can have a telemetry event listener mechanism utilized for monitoring user activity. The telemetry event listener mechanism can apply on all telemetry datapoints. The system can add monitoring and processing for needed datapoints. The system can also add another activity listener independent of telemetry datapoints.

Client side datapoint capturing can involve a write to the database each time a datapoint is emitted. The client cache can be refreshed with the same periodic frequency as the recommendations processing. The client cache processing may occur during application idle time. The system can store N aggregated features per group. Based on time windowing, this could be M*N, where M is the number of time bins (e.g., 2). There can be no network overhead when all computations and storage occur on the client device. All data can be stored on the client device in a parallel database with the same level of encryption as other client usage data.

In at least one implementation, the system can utilize server-side processing and an application program interface (API) to publish results to the client. A conventional cosmos to a Kaizala® management service (KMS) pipeline that is used for reports in the chat application management portal can be used. Server-side processing can result in faster model updates, greater control, and minimal client overhead. Server-side processing can also allow for more complex processing on a more larger computing device as well as group and tenant level recommendations. Server-side processing can be integrated with data processing on substrate user shared and augmentation loop. These are existing services of data processing and ML that the system can use to perform server-based communications. Furthermore, server-side processing can handle all client platforms and deal with the cold start problem by using activity data from other users of the chat groups (e.g., popular chat groups are ranked higher). Server-side processing may need more compliance, server processing overhead, and/or overhead of upgradation, migration and scaling up. Additionally, server-side processing may depend on client side datapoint addition to add more features.

Telemetry aggregation and ML model processing can be performed in the same pipeline used for reports in the chat application. The processing cost may be linear in number of users. This could be optimized to only process delta updates each time window. Only final ranked results may be moved to KMS storage. The recommendations processing and data transfer can be performed once per user and once per tenant at a periodic interval (e.g., 24 hours). The processing may be performed during service lean load. The client cache can be refreshed with the same periodic frequency and can occur during application idle time.

The server-side model can store ranked results per group per user and per group per tenant. In at least one implementation, if the number of users=U, number of users per group=G, groups per tenant=G_{T}, number of tenants=T, number of rankings=R, then the amount of storage required=R*U*G+R*T*G_{T}. Regarding network cost, per user recommendations can result in R*G per day. This could further be optimized to update only delta changes.

Telemetry data can be processed and aggregated in the chat application virtual cluster (VC), thereby keeping the access restrictions as is. After the aggregated data is moved, it can be stored in the KMS object store with appropriate tenant and user level data privacy similar to other user data as supported by KMS application program interfaces. The command exposed to the client may have the same access control levels as other KMS commands. In one implementation, partial processing is performed on the client side and further aggregation is performed on the server.

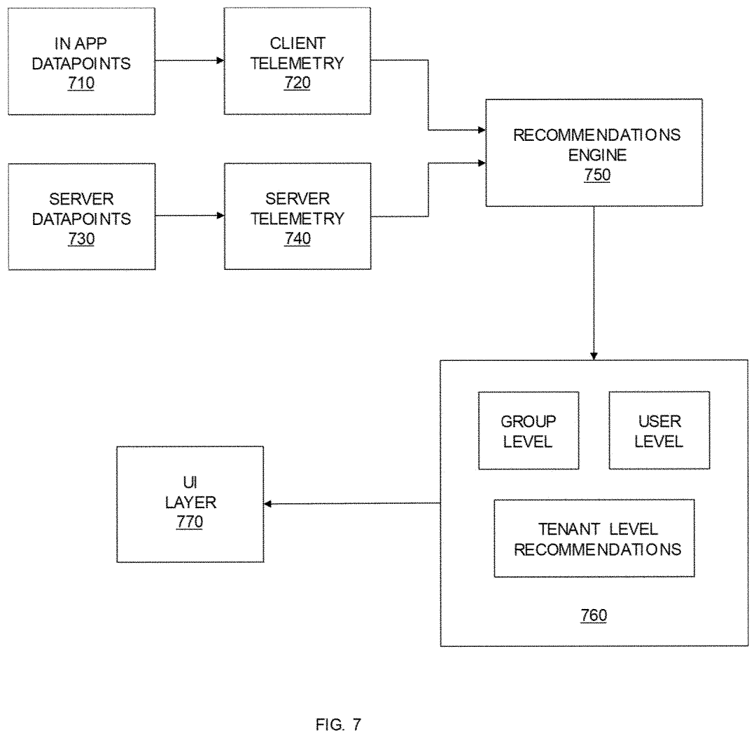

FIG. 7 is a flow diagram illustrating a recommendations data flow where datapoints from the chat application running on the client device 710 can be sent to a client telemetry unit 720. Similarly, datapoints from the server 730 connected to the client devices can be sent to a server telemetry unit 740. Data can be aggregated at the client telemetry unit 720 and the server telemetry unit 740 and sent to the recommendations engine 750. As described above, the recommendations engine 750 can fetch recommendations from storage and receive new recommendations from the recommendations model 760. Data can be sent from the recommendations engine 750 to the recommendations model 760. As also described above, the recommendations model 760 can generate recommendations (also referred to herein as a ranked list of groups) and send the recommendations to the user interface layer 770.

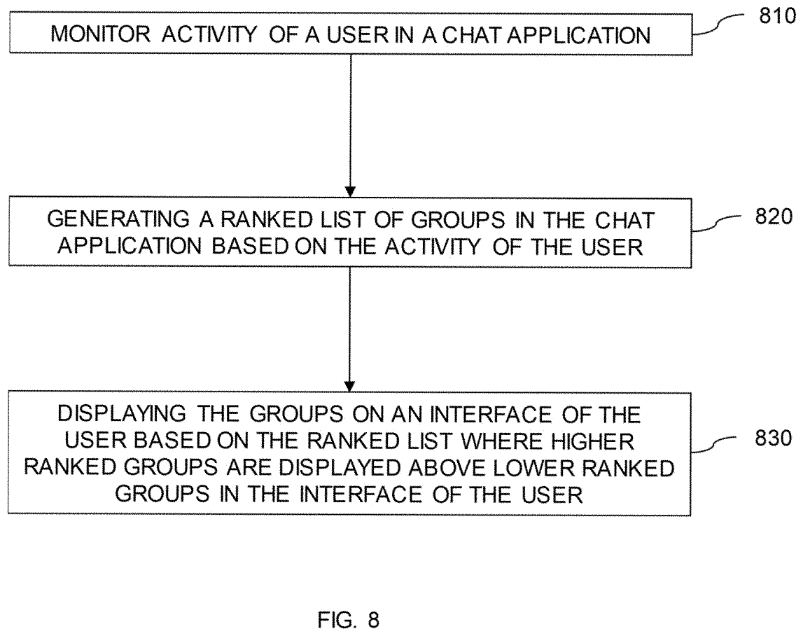

FIG. 8 is a flow diagram illustrating a method for recommending chat groups in a chat application. Activity of a user in a chat application is monitored 810, where the chat application includes an electronic platform for one or more individuals to communicate in a group in real-time over a computer network. The activity of the user can include accessing a group in the chat application (e.g., opening a message in the group), the number of times each group is opened by the user, the number of unread messages in each group, the number of text and graphical messages sent by the user in each group, time spent by the user in each group, and the number of times the user opened a message in each group for the sole purpose of marking the message as read. A ranked list of groups in the chat application is generated based on the activity of the user 820. The groups are displayed on an interface of the user based on the ranked list where higher ranked groups are displayed above lower ranked groups in the interface of the user 830.

Aspects of the present device and methods may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

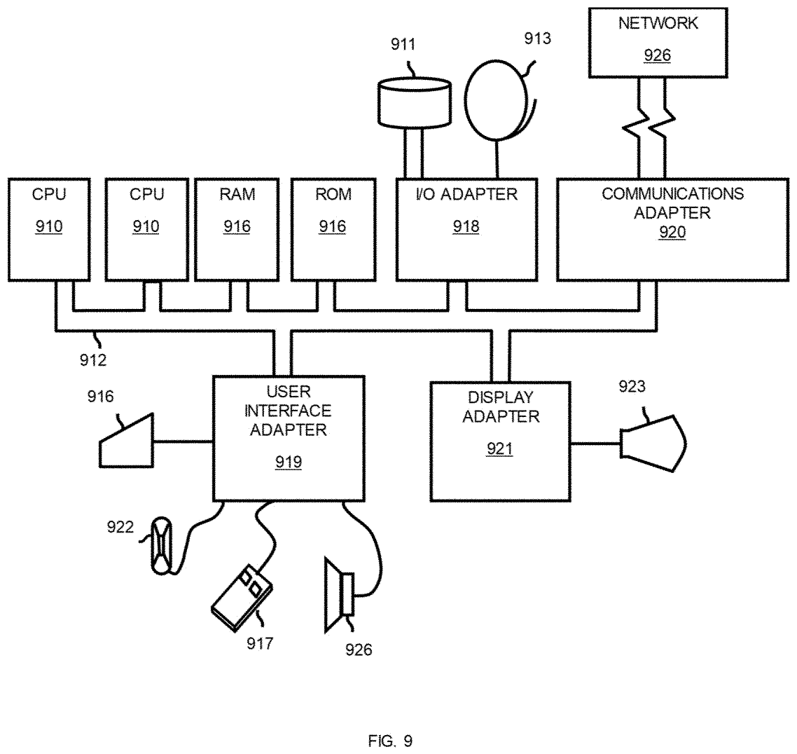

Referring now to FIG. 9, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 910. The CPUs 910 are interconnected with system bus 912 to various devices such as a random access memory (RAM) 914, read-only memory (ROM) 916, and an input/output (I/O) adapter 918. The I/O adapter 918 can connect to peripheral devices, such as disk units 911 and tape drives 913, or other program storage devices that are readable by the system. The system can read the inventive instructions on the program storage devices and follow these instructions to execute the methodology of at least one embodiment of the invention. The system further includes a user interface adapter 919 that connects a keyboard 915, mouse 917, speaker 924, microphone 922, and/or other user interface devices such as a touch screen device (not shown) to the bus 912 to gather user input. Additionally, a communication adapter 920 connects the bus 912 to a data processing network 925, and a display adapter 921 connects the bus 912 to a display device 923 which may be embodied as an output device such as a monitor, printer, or transmitter, for example.

In the following, further features, characteristics and advantages of the system and method will be described by means of items: Item 1. A system comprising: a compiler configured to monitor activity of a user in a chat application, the chat application including an electronic platform for one or more individuals to communicate in a group in real-time over a computer network; a processor connected to the compiler, the processor configured to generate a ranked list of groups in the chat application based on the activity of the user; and a display connected to the processor, the display configured to display the groups on an interface of the user based on the ranked list.

Item 2. The system according to item 1, wherein the activity of the user includes accessing a group in the chat application.

Item 3. The system according to item 1 or 2, wherein the activity of the user includes a number of times each group in the groups in the chat application is opened by the user.

Item 4. The system according to any one of the preceding items, wherein the activity of the user includes a number of unread messages in each group in the groups in the chat application opened by the user.

Item 5. The system according to any one of the preceding items, wherein the activity of the user includes a number of messages sent by the user in each group in the groups in the chat application opened by the user.

Item 6. The system according to any one of the preceding items, wherein the messages sent by the user include text messages, enhanced text messages like meetings invites, announcements, surveys and graphical messages.

Item 7. The system according to any one of the preceding items, wherein the activity of the user includes time spent by the user in each group in the groups in the chat application.

Item 8. The system according to any one of the preceding items, wherein the activity of the user includes a number of times the user opened a message in each group in the groups in the chat application for the sole purpose of marking the message as read.

Item 9. The system according to any one of the preceding items, wherein the activity of the user includes a number of times the user recommended the group or invited an individual to join the group.

Item 10. The system according to any one of the preceding items, wherein the processor is configured to: generate a first ranked list of groups for a first time period, the first ranked list of groups being based on the activity of the user during the first time period; and generate a second ranked list of groups for a second time period different from the first time period, the second ranked list of groups being based on the activity of the user during the second time period and user's historical activity during the first time period, wherein the display is configured to display the first ranked list of groups to the user during the first time period and displays the second ranked list of groups to the user during the second time period.

Item 11. The system according to any one of the preceding items, wherein the processor is located on a device of the user.

Item 12. The system according to any one of the preceding items, wherein the display is configured to display the groups on the interface in a non-chronological order.

Item 13. The system according to any one of the preceding items, wherein the display is configured to display higher ranked groups above lower ranked groups in the interface of the user.

Item 14. A method comprising: monitoring activity of a user in a chat application, the chat application including an electronic platform for one or more individuals to communicate in a group in real-time over a computer network; generating a ranked list of groups in the chat application based on the activity of the user; and displaying the groups on an interface of the user based on the ranked list where higher ranked groups are displayed above lower ranked groups in the interface of the user.

Item 15. The method according to item 14, wherein the activity of the user includes accessing a group in the chat application.

Item 16. The method according to item 14 or 15, wherein the activity of the user includes a number of times each group in the groups in the chat application is opened by the user.

Item 17. The method according to any one of the preceding items, wherein the activity of the user includes a number of unread messages in each group in the groups in the chat application opened by the user.

Item 18. The method according to any one of the preceding items, wherein the activity of the user includes a number of messages sent by the user in each group in the groups in the chat application opened by the user, wherein the messages sent by the user include text messages, enhanced text messages like meetings invites, announcements, surveys and graphical messages.

Item 19. The method according to any one of the preceding items, wherein the activity of the user includes time spent by the user in each group in the groups in the chat application.

Item 20. A computer program product comprising: a computer readable storage medium having encoded thereon: first program instructions executable by a device to cause the device to monitor activity of a user in a chat application, the chat application including an electronic platform for one or more individuals to communicate in a group in real-time over a computer network; second program instructions executable by the device to cause the device to generate a ranked list of groups in the chat application based on the activity of the user; and third program instructions executable by the device to cause the device to display the groups on an interface of the user based on the ranked list.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

1. A system for generating a chat group recommendation, comprising:
a processor; and
a memory in communication with the processor, the memory comprising executable instructions that, when executed by the processor, cause the processor to control the system to perform:
monitoring a plurality of operations carried out in relation to a plurality of chat groups associated with a real-time chat application, each operation being initiated in response to an input received via a user interface;
based on the plurality of monitored operations, determining a metric of each chat group, the metric being indicative of a number of times each chat group is opened to mark unread messages as read;
ranking, based on the determined metric, the plurality of chat groups; and
displaying, via the user interface, a recommended chat group list comprising at least some of the plurality of chat groups selected and arranged based on the ranking of the plurality of chat groups.

2. The system of claim 1, wherein the plurality of operations includes accessing each chat group.

3. The system of claim 1, wherein the metric is further indicative of a number of times each chat group is opened.

4. The system of claim 1, wherein the metric is further indicative of a number of unread messages in each chat group.

5. The system of claim 1, wherein the metric is further indicative of a number of sent messages in each chat group.

6. The system of claim 5, wherein the sent messages include a text messages, enhanced text message, or graphical message.

7. The system of claim 1, wherein the metric is further indicative of an amount of time spent by a user in each chat group.

8. (canceled)

9. The system of claim 1, wherein the metric is further indicative of a number of times a user recommended each chat group or invited an individual to join each chat group.

10. The system of claim 1, wherein:
the instructions, when executed by the processor, further cause the processor to control the system to perform:
generating, based on the plurality of operations during a first time period, a first ranked list of chat groups for the first time period; and
generating, based on the plurality of operations during a second time period, a second ranked list of chat groups for the second time period different from the first time period, and
for displaying the recommended chat group list, the instructions, when executed by the processor, further cause the processor to control the system to perform:
displaying, during the first time period, the first ranked list of chat groups; and
displaying, during the second time period, the second ranked list of chat groups.

11. The system of claim 1, wherein the system comprises a user device.

12. The system of claim 1, wherein, in the recommended chat group list displayed via the user interface, the chat groups are arranged in a non-chronological order.

13. The system of claim 1, wherein, in the recommended chat group list displayed via the user interface, a first chat group having a first ranking is arranged above a second chat group having a second ranking lower than the first ranking.

14. A method for generating a chat group recommendation, comprising:
monitoring a plurality of operations carried out in relation to a plurality of chat groups associated with a real-time chat application, each operation being initiated in response to an input received via a user interface;
based on the plurality of monitored operations, determining a metric of each chat group, the metric being indicative of a number of times each chat group is opened to mark unread messages as read;
ranking, based on the determined metric, the plurality of chat groups; and
displaying, via the user interface, a recommended chat group list comprising at least some of the plurality of chat groups selected and arranged based on the ranking of the plurality of chat groups.

15. The method of claim 14, wherein the plurality of operations includes accessing each chat group.

16. The method of claim 14, wherein the metric is further indicative of a number of times each chat group is opened.

17. The method of claim 14, wherein the metric is further indicative of a number of unread messages in each chat group.

18. The method of claim 14, wherein the metric is further indicative of a number of sent messages in each chat group.

19. The method of claim 14, wherein the metric is further indicative of an amount of time spent by a user in each chat group.

20. A non-transitory computer readable medium containing instructions which, when executed by a processor, cause the processor to control a system to perform comprising:
monitoring a plurality of operations carried out in relation to a plurality of chat groups associated with a real-time chat application, each operation being initiated in response to an input received via a user interface;
based on the plurality of monitored operations, determining a metric of each chat group, the metric being indicative of a number of times each chat group is opened to mark unread messages as read;
ranking, based on the determined metric, the plurality of chat groups; and
displaying, via the user interface, a recommended chat group list comprising at least some of the plurality of chat groups selected and arranged based on the ranking of the plurality of chat groups.
